(19) United States
(12) Patent Application Publication
(10) Pub. No.: US 2021/0161223 A1
(43) Pub. Date: Jun. 3, 2021

(54) Finger Sheath Assemblies and Methods of Using the Sheath Assemblies to Massage or Scratch an Animal

(71) Applicant: Vathana Lotsana, Denver, CO (US)

(72) Inventor: Vathana Lotsana, Denver, CO (US)

(21) Appl. No.: 16/678,608

(22) Filed: Dec. 2, 2019

(51) Int. Cl. A41D 13/08; A46B 5/04; A01K 13/00

(52) U.S. Cl. CPC A41D 13/087; A01K 13/001; A46B 5/04

(57) ABSTRACT

One or more rigid finger sheath assemblies that terminate in a blunt pointed ends are described. Some variations resemble a claw. Generally, embodiments of each sheath assembly include a rigid sleeve with a closed distal end that forms a chamber accessible only from an open proximal end wherein the finger can be slid therein. To secure the sheath assembly to the finger regardless of what finger and the size thereof, the interior of rigid sleeve includes a compressible foam affixed therein.

### SCOPE OF THE INVENTION

The present invention pertains to rigid finger sheath assemblies and the methods of using the sheath assemblies to massage, pet or scratch an animal.

### BACKGROUND

Traditionally, people pet their pets, such as dogs, with their hands and fingers occasionally using their fingertips and fingernails to lightly scratch their pets. Some pets, and dogs in particular, enjoy being scratched, which can act to loosen dander and dead skin that could otherwise cause them to itch.

Products have been created to help pet, scratch or groom a pet. For instance, gloves with specially configured surfaces are known to help in petting an animal and removing loose fur. Brushes with specific bristles are known for both removing loose fur and gently scratching the animal's skin underneath. However, none of these device are designed to optimize the scratching of a pet in a manner that does not run the risk of damaging the pet's skin.

### DRAWINGS

FIGS. 1a & 1b are perspective and cross sectional views respectively of a rigid finger sheath assembly according to a first embodiment of the present invention.

FIGS. 2a & 2b are perspective and cross sectional views respectively of a rigid finger sheath assembly according to a second embodiment of the present invention.

FIG. 3 is an illustration showing five finger sheath assemblies received over all five fingers of a hand according to an embodiment of the present invention.

### DETAILED DESCRIPTION

Embodiments of the present invention comprise one or more rigid finger sheath assemblies that terminate in a blunt pointed end. Some variations resemble a claw. Generally, embodiments of each sheath assembly include a sleeve with a closed distal end that forms a chamber accessible only from an open proximal end wherein the finger can be slid therein. The inside diameter of the part of the sleeve wherein in a finger is to be received is larger than the diameter of the largest finger of a typical or average hand whereby the same sleeve can received over any finger of the hand.

To secure embodiments of the sheath assembly to a finger regardless of what finger and the size thereof, the interior of sleeve includes a compressible foam affixed therein. When placed over the finger the foam compresses and then expands to lightly press against the finger and secure it in place within the sleeve. The configuration of the foam material can vary. In some variations, it comprises a piece located on a bottom interior side of the sleeve. In others, it forms a tubular sleeve within the rigid sleeve configured to cradle the finger from all sides.

The configuration of the rigid sleeve itself can vary significantly and substantially among embodiments. In the figures, the sleeve resembles an animal claw; however, other configurations are known and contemplated.

In use, one or more sheath and typically a plurality of four or five are placed over the fingers on a hand held in place by the compressed foam. The blunt pointed ends can then be used to pet or massage an animal, such as a dog.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “blunt pointed end” and similar terms as used herein refer to a point that is not sharp enough to puncture the skin of a dog or a person when pressed into the skin with anything other than extraordinary force. Some variations of a blunt pointed end have an effective radius of about 0.20″ or greater.

### A First Embodiment of a Finger Sheath Assembly

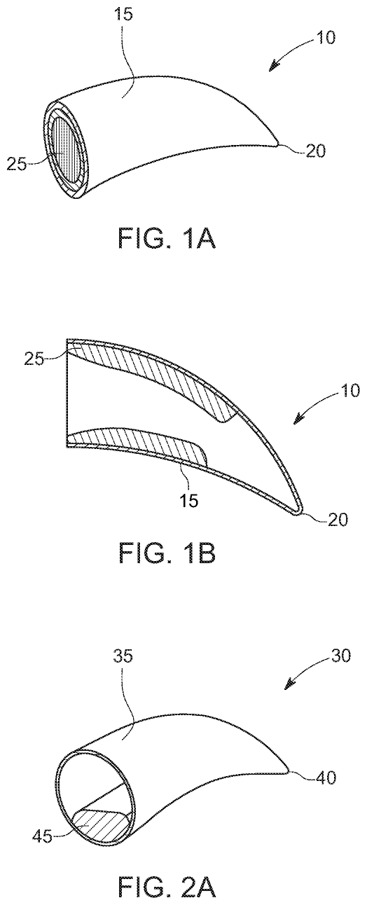

FIGS. 1a&b are illustrations of a first embodiment of a rigid finger sheath assembly 10. The sheath assembly comprises two primary components: a rigid sleeve 15 generally shaped like a claw that terminated in a distal blunt pointed end 20; and a generally tubular foam sleeve 25 that is received in and secured to the interior of the rigid sleeve.

The rigid sleeve 15 can be comprised of any suitable material and made using any suitable process, but is most commonly comprised of a polymeric material that is injection molded into the desired shape. Other possible materials that can be used to construct the sheath include various metals, wood, or even a pulp-based composite. Other possible manufacturing processes include blow molding, and 3D printing.

The rigid sleeve, as shown, is shaped like an animal's claw being generally conical but curving towards a pointed but blunt distal end 20. Other shapes are contemplated including a more traditional conical shape eschewing the curve. The interior of the sleeve is substantially hollow and of a size to permit the sleeve to be received over the middle finger at least up to the carpometacarpal joint thereof. As a consequence, the sheath assembly can typically be received over any of the other fingers of a hand as well. The exterior and interior surface textures of the sleeve are typically smooth but are not necessarily so.

Of importance is the blunt end or tip of the sheath since the sheath assemblies typical purpose is to pet or massage an animal. The degree of bluntness can vary but ultimately, the point should not be so sharp as to risk puncturing or damaging the skin of an animal during normal use.

To hold the sheath assembly in place and to self-adjust for the particular size of finger inserted into the sheath assembly, the foam sleeve 25 is provided lining the interior surface of the sleeve 15. The foam sleeve is typically adhesively secured to the interior surface. The end of the foam sleeve near the proximal end of the rigid sleeve is typically beveled permitting a finger to be more easily inserted therein. As the finger is slid into the sheath assembly, the foam compresses and forms around the finger applying a light force against the finger and effectively holding it in place while the sheath assembly is used to pet an animal.

The foam sleeve 25 can be made of any suitable foam material. Both open and closed cell foam can be utilized. Viscoelastic foam, also known as memory foam, can also be used as it can act to temporarily mold itself around a finger inserted into it.

### A Second Embodiment of a Finger Sheath Assembly

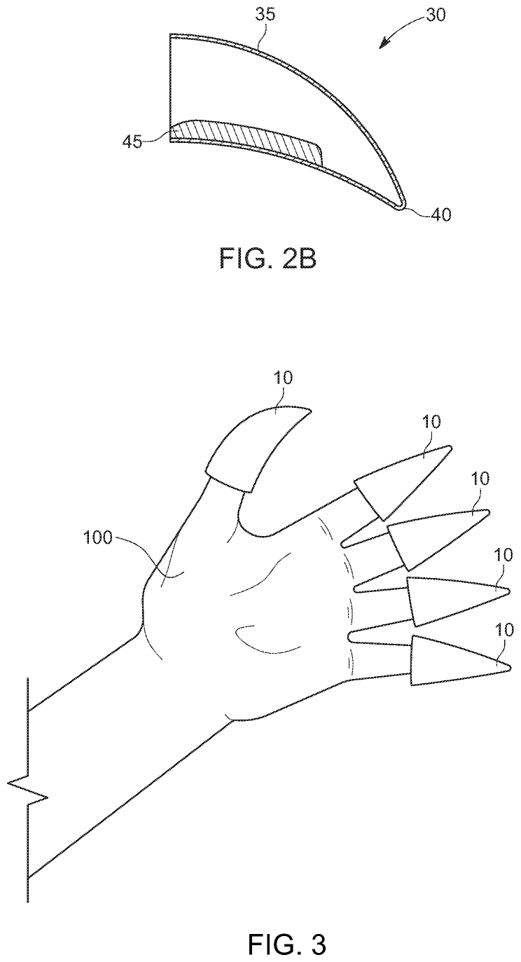

FIGS. 2a&b are illustrations of a second embodiment of a rigid finger sheath assembly 30. Like the first embodiment 10, the second embodiment sheath assembly comprises two primary components: a rigid sleeve 35 generally shaped like a claw that terminates in a distal blunt pointed end 40; and a foam piece 45. The rigid sleeve of this embodiment is substantially similar to the sleeve described concerning the previous embodiment. However, instead of being a foam sleeve, the foam piece comprises an elongated piece that is typically secured to the bottom portion of the rigid sleeve's interior.

As illustrated, a single elongated piece of foam 45 is adhesively or otherwise secured to the interior bottom of the sleeve 35. In variations the length, width and thickness of the piece of foam can vary as can the location of the foam within the rigid sleeve. The foam material can be of any suitable type as described above concerning the first embodiment. The foam piece acts to hold a finger, which can be of various sizes, in the sheath assembly 30 while it is being used to pet or scratch an animal.

As can be appreciated other variations on the foam piece 45 are contemplated. For instance, multiple foam pieces can be used instead of a single foam piece. A single generally rectangular piece can be formed into a sleeve, or a substantial portion of a sleeve, within the rigid sheath and adhesively bonded in place. Further, a rubber material, a gel-like material and/or viscoelastic material that can be compressed, or viscoelastically flow around a finger, and is resilient can be substituted for the foam.

### Method(s) of Using the Finger Sheath Assemblies

As indicated above, the sheath assembly 10,30 is used to pet or massage an animal, typically a dog or other pet. A single sheath assembly received over a finger can be used for this purpose, but more typically, a plurality of sheaths are used either on one hand or both of the user. Accordingly, the sheath assemblies are typically provided packaged in groups of at least three and more typically five or ten.

In use, the sheath assemblies 10,30 are slid onto a user's fingers. As a sheath assembly is slid in place on finger, the foam 25,45 compresses. After the finger is fully received in place, the foam expands around the finger apply a gentle force there against to effectively hold the sheath assembly in place. FIG. 3 illustrates sheath assemblies received over all five fingers on a hand 100.

Next, the user can scratch or pet an animal moving the blunt pointed ends 25,40 of the sleeve across an animal's skin while applying an appropriate level of force. More force is typically applied when scratching an animal's skin; whereas, less force is applied when the sheath assemblies are being used to pet an animal.

Once the user is finished with the sheath assemblies, they are easily slid off of the fingers and stored for later use.

### Variations and Other Embodiments

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A finger sheath assembly comprising:
a generally conical rigid sleeve defining a substantially hollow interior and having a open proximal end and a closed distal end, the distal end forming a blunt point; and
one or more resilient pieces, the resilient pieces being received in the hollow interior and secured to an interior surface of the rigid sleeve;
wherein the sheath assembly is sized to receive and removably secure a human finger therein.

2. The finger sheath assembly of claim 1, wherein the rigid sleeve curves along its length.

3. The finger sheath assembly of claim 2, wherein the rigid resembles a claw of an animal.

4. The finger sheath assembly of claim 1, wherein the rigid sleeve comprises a polymeric material.

5. The finger sheath assembly of claim 1, wherein the one or more resilient pieces comprise one or more foam pieces.

6. The finger sheath assembly of claim 5, wherein the one or more foam pieces comprise a foam sleeve.

7. The finger sheath assembly of claim 5, wherein the one or more foam pieces comprise a viscoelastic material.

8. The finger sheath assembly of claim 5, wherein the one or more foam pieces comprise one or more elongated strips.

9. The finger sheath assembly of claim 5, wherein the one or more foam pieces are adhesively secured to an interior surface of the rigid sleeve.

10. In combination, three or more finger sheath assemblies of claim 1, each assembly being the same size as the other assemblies.

11. The combination of claim 10, furthering including packaging wherein the three or more finger sheath assemblies are received in the packaging.

12. The combination of claim 11, wherein the three or more finger sheath assemblies comprise five finger sheath assemblies.

13. A method of using the combination of claim 10 comprising:
placing each of the three or more finger sheath assemblies on a finger of a hand; and
scratching an animal by moving the blunt point over across the animals skin while applying pressure.

14. The method of claim 13, further comprising removing each of the three or more finger sheath assemblies from each of the respective fingers.
